(19) United States
(12) Patent Application Publication
(10) Pub. No.: US 2004/0022252 A1
(43) Pub. Date: Feb. 5, 2004

(54) Apparatus and method for compressing headers and multiplexing packets in IP-based network environment

(75) Inventors: Won-kap Jang, Seongnam-si (KR); Jin-woo Hong, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/437,451

(22) Filed: May 14, 2003

(30) Foreign Application Priority Data
Jun. 26, 2002 (KR) 2002-36067

(51) Int. Cl. H04L 12/28

(52) U.S. Cl. 370/395.52; 370/471

(57) ABSTRACT

An apparatus and a method for compressing a header and multiplexing a packet in an IP-based network environment without adopting PPP tunneling are provided. The apparatus and the method compress a UDP header and an RTP header and specify a protocol type indicating that the UDP and RTP headers have been compressed independently of a link layer in an IP header. The apparatus includes a protocol type designator which specifies a protocol type in an IP header included in a packet having a non-compressed header when the packet is received, a header compressor which generates the packet having the IP header, the protocol type of which has been designated as a packet having one of a full header format, a compressed RTP (C_RTP) header format, and a compressed UDP (C_UDP) header format, and a packet multiplexer which multiplexes a packet generated by the header compressor.

### BACKGROUND OF THE INVENTION

This application claims the priority of Korean Patent Application No. 2002-0036067, filed Jun. 26, 2002, in the Korean Intellectual Property Office, the disclosure of which is incorporated herein in its entirety by reference.

1. Field of the Invention

The present invention relates to an apparatus and a method for compressing a header and multiplexing a packet in an Internet Protocol (IP)-based network environment, and more particularly, to an apparatus and a method for compressing a header and multiplexing a packet irrespective of a link layer.

2. Description of the Related Art

A next-generation network (NGN), in which all networks are integrated into one network, adopts an All-IP concept based on an IP packet network. Research has been carried out on improved Voice-over-IP (VoIP) techniques, such as Internet telephone services, Internet faxes, web calls, and integrated message processing, which are NGN services adopting the All-IP concept. It is very important to effectively use network bandwidth to realize such service techniques. Accordingly, as part of the efforts to effectively use network bandwidth, methods for compressing header information have been suggested.

One of the methods for compressing header information is a Compressed Real-time Transport Protocol (CRTP) method capable of reducing overhead caused by a header during transmission of data on a low-speed serial link. The CRTP method suggests a technique of decreasing the length of an IP/User Datagram Protocol (UDP)/Real-time Transport Protocol (RTP) header from about 40 bytes to 2-4 bytes if the length of payload is small, such as voice data. In other words, the CRTP method compresses redundant parts in the IP/UDP/RTP header and fields having a value varying in a regular pattern, taking advantage of conditions supported by a Point-to-Point Protocol (PPP), including the specification of the type and length of a packet and the detection of errors.

However, since the CRTP method compresses an IP header as well, the CRTP method can only be applied to an environment providing specific conditions, such as the PPP. The link layer of an IP network is not a PPP, and thus, it is necessary to build a PPP tunnel to transmit a compressed packet over the link layer. In addition, in the IP network, since a new IP is additionally generated for routing, a new header of 20 bytes is also generated in the compressed packet. In addition, multiplexing and compression cannot be performed outside the PPP tunnel.

Another method for compressing a header is an Enhanced Compressed RTP (ECRTP) method. The ECRTP method is a modification of the CRTP method in that packets are smoothly transmitted even when some of the packets are missing. However, the ECRTP method, as well, can only be applied to a network environment supporting PPP.

Still another method for compressing a header is a Tunneling Multiplexed Compressed RTP (TCRTP) method. The TCRTP method suggests a technique of compressing a header over an IP network with the PPP. The TCRTP reduces the length of a header and transmits data over an IP network by using IP/UDP/RTP header compression, PPP multiplexing, and layer 2 tunneling. However, when applied to a general IP network that does not adopt PPP, the TCRTP method is required to build a PPP tunnel so that a new IP header of 20 bytes for IP routing is additionally generated.

Accordingly, the compression rate of a header, which has been reduced to 2-4 bytes, decreases due to an overhead that amounts to 20 bytes. In addition, a header, which has not yet been compressed, may be transmitted in a specific section where the PPP tunnel is not provided.

### SUMMARY OF THE INVENTION

The present invention provides an apparatus and a method for compressing a header and multiplexing a packet in an IP-based network not adopting a Point-to-Point Protocol (PPP).

The present invention also provides an apparatus and a method for compressing a header and multiplexing a packet in an IP-based network. The apparatus and the method are capable of simplifying a compression process by compressing a UDP/RTP header without using PPP tunneling and transmitting a compressed header in a section where PPP tunneling is not provided.

The present invention also provides an apparatus and a method for compressing a header and multiplexing a packet independently to a link layer by specifying the type of protocol in an IP header.

According to an aspect of the present invention, there is provided an apparatus for compressing a header and multiplexing a packet in an Internet Protocol (IP)-based network environment. The apparatus includes a protocol type designator which specifies a protocol type in an IP header included in a packet having a non-compressed header when the packet is received, a header compressor which generates the packet having the IP header, the protocol type of which has been designated as a packet having one of a full header format, a compressed RTP (C_RTP) header format, and a compressed UDP (C_UDP) header format, and a packet multiplexer which multiplexes a packet generated by the header compressor.

Preferably, but not necessarily, a packet having the full header format is the same as the format of the non-compressed header and the packet can include a packet type, a context identification (CID), a sequence number (SEQUENCE_NUMBER), a generation number (GENERATION_NUMBER), and a header check sum (C_BIT) using a length field of a UDP header included in the non-compressed header.

Preferably, but not necessarily, the header compressor does not include an IP address in the CID.

Preferably, but not necessarily, the header compressor generates a packet having the compressed RTP header format by compressing a field among RTP header fields, which varies regularly or is maintained at a predetermined value.

Preferably, but not necessarily, the header compressor generates a packet having the compressed UDP header format if the compressed RTP header format varies irregularly.

Preferably, but not necessarily, the packet multiplexer performs RTP packet multiplexing so that a loss in network bandwidth, which is caused by a non-compressed IP header of the packet input from the header compressor, can be reduced.

Preferably, but not necessarily, the header compressor generates a packet having the full header format when a context state packet is received from a terminal, which has transmitted the packet via a network.

According to another aspect of the present invention, there is provided an apparatus for multiplexing a packet in an IP-based network environment. The apparatus includes a multiplexer which, if packets each having a compressed header are generated by a plurality of servers, multiplexes the packets and generates a multiplexed packet having a multiplexing indication (MI) field, a multiplexing identification extension (MXT) field, a multiplexing identification (MID) field, and an IP indication field.

According to still another aspect of the present invention, there is provided a method of compressing a header and multiplexing a packet in an IP-based network environment. The method involves specifying a protocol type in an IP header of a packet having a non-compressed header when the packet is received, generating a packet having a compressed header of a full header format, a compressed RTP (C_RTP) header format, or a compressed UDP (C_UDP) header format depending on an operational condition during transmission of the packet, and multiplexing the generated packet and transmitting the multiplexed packet to a network.

Preferably, but not necessarily, in the generation of the packet, a packet having the full header format is generated using a length field of a UDP header included in the non-compressed header so that the full header format is the same as the format of the non-compressed header and the packet can include a packet type, a CID, a sequence number (SEQUENCE_NUMBER), a generation number (GENERATION_NUMBER), and a header check sum (C_BIT).

Preferably, but not necessarily, in the generation of the packet, an IP address is not included in the CID.

Preferably, but not necessarily, in the multiplexing of the packet, the packet is multiplexed through RTP packet multiplexing so that a loss in network bandwidth, which is caused by a non-compressed IP header of the packet input in the compression of the header, can be reduced.

Preferably, but not necessarily, in the compression of the header, a packet having the full header format is generated when a context state packet is received from a terminal where the packet has been transmitted via the network.

### BRIEF DESCRIPTION OF THE DRAWINGS

The above features and advantages of the present invention will become more apparent by describing in detail exemplary embodiments thereof with reference to the attached drawings in which:

FIG. 1 is a diagram illustrating an example of an IP-based network environment including an apparatus for compressing a header and multiplexing a packet according to a preferred embodiment of the present invention;

FIG. 2 is a diagram illustrating the format of a UDP length field of a full header generated according to the present invention;

FIG. 3 is a diagram illustrating the format of a compressed RTP (C_RTP) header generated according to the present invention;

FIG. 4A is a diagram illustrating the format of a compressed UDP (C_UDP) header generated according to the present invention;

FIG. 4B is a diagram illustrating the format of a UDP header field added when F=1 in the C_UDP shown in FIG. 4A;

FIG. 5 is a diagram illustrating the format of a multiplexed packet generated by the unit for compressing a header and multiplexing a packet shown in FIG. 1;

FIG. 6 is a diagram illustrating the format of a CONTEXT_STATE packet;

FIG. 7 is a diagram illustrating an example of an IP-based network, to which an apparatus for compressing a header and multiplexing a packet according to another preferred embodiment of the present invention is applied;

FIG. 8 is a diagram illustrating the format of a packet multiplexed by a multiplexer shown in FIG. 7;

FIG. 9 is a flowchart of a method of compressing a header and multiplexing a packet according to a preferred embodiment of the present invention; and

FIG. 10 is a flowchart of an operation of an end terminal performed on a packet received using the method of compressing a header and multiplexing a packet shown in FIG. 9.

### DETAILED DESCRIPTION OF THE INVENTION

Hereinafter, the present invention will be described more fully with reference to the accompanying drawings, in which illustrative, non-limiting embodiments of the invention are shown.

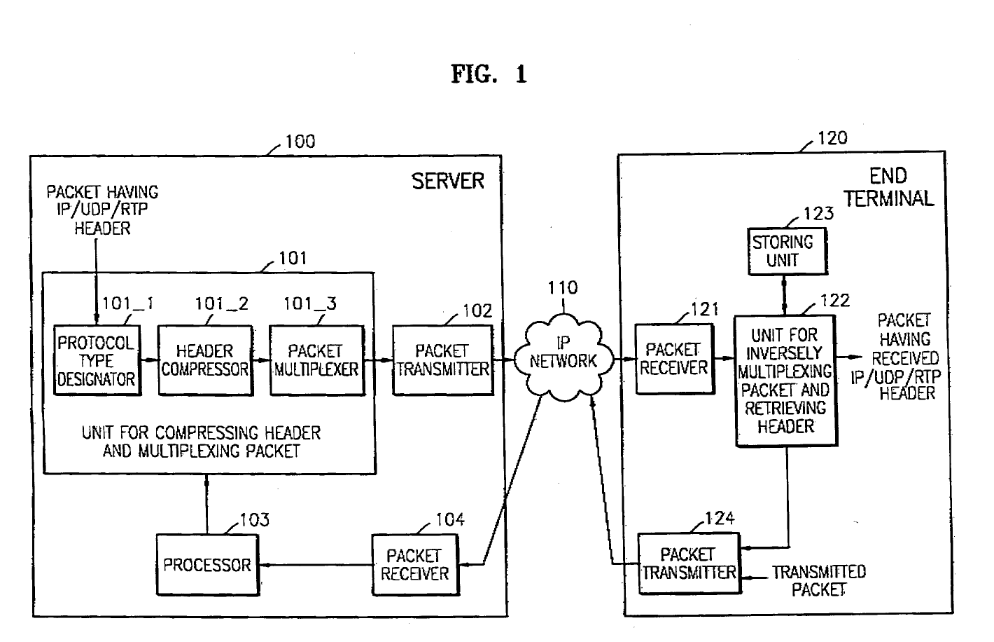

FIG. 1 is a diagram illustrating an example of an IP-based network environment including an apparatus for compressing a header and multiplexing a packet according to an illustrative, non-limiting embodiment of the present invention. Referring to FIG. 1, an IP-based network environment includes a server 100, an IP network 110, and an end terminal 120.

The server 100 compresses a header, multiplexes a packet, and transmits the multiplexed packet over the IP-based network 110 without using PPP. For this purpose, the server 100 includes a unit 101 for compressing a header and multiplexing a packet, a packet transmitter 102, a processor 103, and a packet receiver 104.

When a packet including an IP/UDP/RTP header, which is not compressed, is input, the unit 101 for compressing a header and multiplexing a packet specifies the type of protocol in an IP header and generates a header having a format independent of a link layer. The type of protocol specified in the IP header indicates that the corresponding packet is operated independently of the link layer. In addition, the unit 101 for compressing a header and multiplexing a packet compresses the UDP header and the RTP header rather than the IP header. The unit 101 for compressing a header and multiplexing a packet may generate a full header (full_header) format, a compressed RTP (C_RTP) format, or a compressed UDP (U_RTP) format.

The unit 101 for compressing a header and multiplexing a packet generates a packet having a full header format before using the compressed header so as to share context information with an apparatus for receiving and transmitting packet data, for example, the end terminal 120. Even when data transmission has already started, a context has been changed, and the context of the unit 101 for compressing a header and multiplexing a packet is not synchronized with that of the end terminal 120, the unit 101 for compressing a header and multiplexing a packet generates a packet having a full header format. The generation of the packet having a full header format is performed under the control of the processor 103.

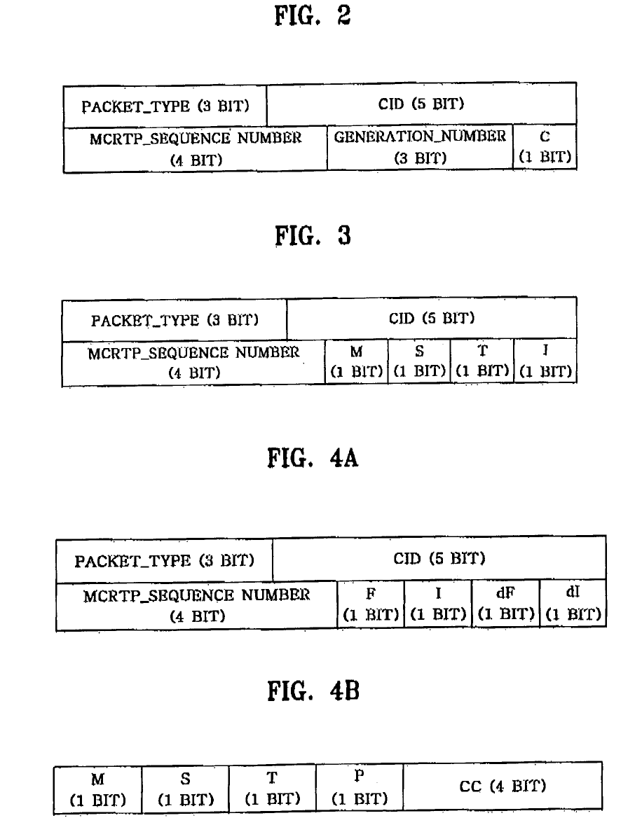

The full header generated by the unit 101 for compressing a header and multiplexing a packet has the same format as an IP/UDP/RTP header, which has not yet been compressed. However, the full header is generated to include new information, such as a packet type (PACKET_TYPE), context identification (CONTEXT_ID), a sequence number (MCRTP_SEQUENCE_NUMBER), a generation number (GENERATION_NUMBER), and a header check sum (C_BIT) by using a length field of the UDP header. When the length field of the UDP header is 16 bits, a length field of a UDP header of the full header is defined as shown in FIG. 2. The PACKET_TYPE field (3 bits) shown in FIG. 2 indicates the type of a packet. The types of packets indicated by the PACKET_TYPE field are shown in Table 1 below.

TABLE 1

| Values | Packet types (PACKET_TYPE) |
|---|---|
| 000 | Full header |
| 001 | Compressed UDP header |
| 010 | Compressed RTP header |
| 011 | CONTEXT_STATE |
| 100 | Packet multiplexed in end-to-end |
| 101 | Packet multiplexed during multiplexing period |

In the context identification (CID) field, a source UDP port number, a destination UDP port number, and information on a specific number given to each RTP synchronization source (SSRC) are recorded. An IP address is not included in the context identification (CID) field so that a tunnelling technique is not used between the server 100 and the end terminal 120. The MCRTP_SEQUENCE_NUMBER field is used to detect and correct errors as a serial number given to multiplexed compressed RTP (MCRTP). A value, which increases by 1 whenever the context identification (CID) field varies, is recorded in the GENERATION_NUMBER field. The C field is an MCRTP check sum when there is no UDP check sum.

In the RTP header field, if there exists a field, which varies regularly or is maintained at a predetermined value, the unit 101 for compressing a header and multiplexing a packet compresses the UDP/RTP header field so that a packet having a C_RTP header can be generated. The unit 101 for compressing a header and multiplexing a packet compares a header included in a previously transmitted packet with a header included in a packet currently being transmitted and then determines whether or not there exists a field, which varies regularly or is maintained at a predetermined value.

The C_RTP header generated by the unit 101 for compressing a header and multiplexing a packet has a format shown in FIG. 3. FIG. 3 shows a 16-bit long C_RTP header field. In FIG. 3, M, S, T, and I represent an RTP marker bit of a packet, an RTP sequence number, an RTP time stamp, and an IP packet identification, respectively.

When the RTP header fields vary irregularly, and as a result, it is impossible to use a C_RTP packet, the unit 101 for compressing a header and multiplexing a packet compresses the UDP/RTP header field so that a packet having a C_UDP header can be generated. Also, when the RTP header fields vary irregularly, the unit 101 for compressing a header and multiplexing a packet compresses the UDP/RTP header field using a C_UDP header or its variation which supports the compression of fields that cannot be represented by a C_RTP. The format of the C_UDP header generated by the unit 101 for compressing a header and multiplexing a packet is shown in FIG. 4A. In FIG. 4A, an F field is information on whether or not an additional flag exists, an I field is an IP packet identification, and d in a dF or dI field represents delta indicating variations in the F field or the I field.

If the F field has a value of 1, the unit 101 for compressing a header and multiplexing a packet generates a C_UDP header, which further includes an RTP header field shown in FIG. 4B. In the RTP header field of FIG. 4B, P is a payload type of an RTP and CC is the number of CSRC (contributing sources).

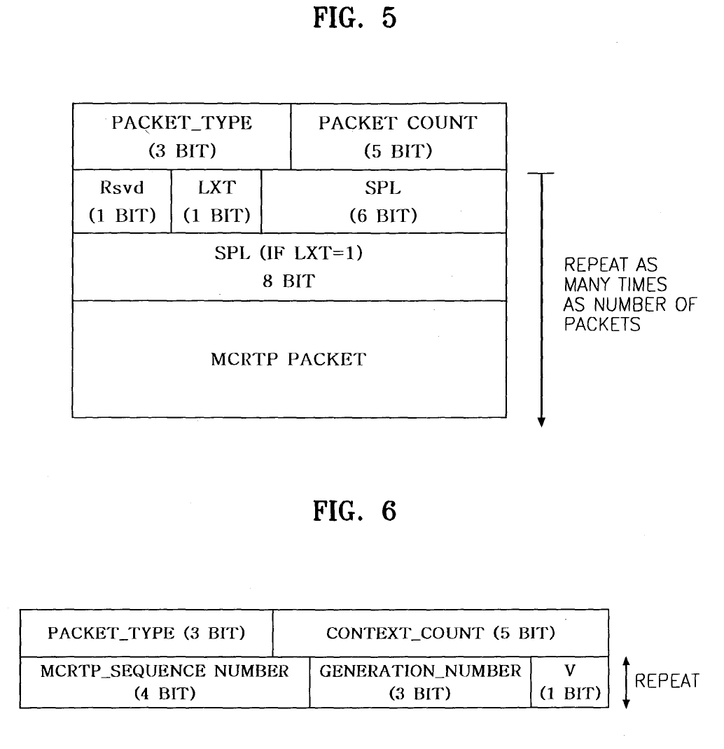

In order to reduce a network bandwidth loss caused by the fact that the unit 101 for compressing a header and multiplexing a packet does not compress an IP header, the unit 101 for compressing a header and multiplexing a packet multiplexes an RTP packet so that an IP header, which repeats for routing, can be omitted. The format of a packet multiplexed by the unit 101 for compressing a header and multiplexing a packet is shown in FIG. 5. Fields of the multiplexed packet shown in FIG. 5 are shown in Table 2 below.

TABLE 2

| Fields (number of bits) | Functions |
|---|---|
| PACKET_COUNT (5) | Number of multiplexed packets |
| LXT (1) | Length extension |
| SPL (6 or 14) | Sub-packet length |

Referring to FIG. 5, when the LXT bit is 0, the length of the SPL field is 7 bits. On the other hand, when the LXT bit is 1, the length of the SPL field is 15 bits. Multiplexing in an end-to-end level supports multiplexing between different media using a different port. A length field, which indicates the length of each packet constituting the multiplexed packet, is added in front of the multiplexed packet shown in FIG. 5.

In order to operate in the aforementioned manner, the unit 101 for compressing a header and multiplexing a packet may be constituted to include a protocol type designator 101_1, which specifies a protocol type in an IP header included in a packet having a non-compressed IP/UDP/RTP header when the packet is received; a header compressor 101_2, which generates a packet including a header having a designated protocol type as a packet having one of a full header format, a compressed RTP (C_RTP) header format, and a compressed UDP (C_UDP) header format; and a packet multiplexer 101_3, which generates a packet by multiplexing a packet generated by the header compressor 101_2.

When a multiplexed packet having a compressed header is output from the unit 101 for compressing a header and multiplexing a packet, the packet transmitter 102 transmits the multiplexed packet to the IP network 110.

The packet receiver 104 receives a packet transmitted from the IP network 110 and transmits the packet to the processor 103. In a case where packets can be transmitted between the server 100 and the end terminal 120, a packet having a compressed header is received from the end terminal 120 in the same manner as in the server 100 when the contexts of the packets are synchronized. However, if the contexts of the packets are not synchronized, a context state packet (CONTEXT_STATE) for correcting errors may be received.

When a packet having a compressed header is received, the processor 103 restores the packet appropriately. However, in a case where the context state packet (CONTEXT_STATE) is input, the processor 103 controls the unit 101 for compressing a header and multiplexing a packet so as to generate a packet having a full header.

The IP network 110 is a network where a PPP tunnel is not generated between the server 100 and the end terminal 120.

When a multiplexed packet is received through the IP network 110, the end terminal 120 inversely multiplexes the multiplexed packet and retrieves a compressed header in the inversely multiplexed packet. If the context of the compressed header of the inversely multiplexed packet is not synchronized with the context of a previously received header, the end terminal 120 does not retrieve the compressed header and transmits the context state packet (CONTEXT_STATE) to the server 100 through the IP network 110. It is possible to check whether the context of the compressed header is synchronized with the context of the previously received header using information, such as a SEQUENCE_NJMBER or a check sum.

The end terminal 120 includes a packet receiver 121, a packet inverse multiplexing and header retrieving unit 122, a storing unit 123, and a packet transmitter 124.

The packet receiver 121 receives a packet transmitted from the IP network 110 and transmits the packet to the unit 122 for inversely multiplexing a packet and retrieving a header.

The unit 122 for inversely multiplexing a packet and retrieving a header inversely multiplexes the packet output from the packet receiver 121 in a manner inverse to the multiplexing method performed in the unit 101 for compressing a header and multiplexing a packet and retrieves a compressed header. The unit 122 for inversely multiplexing a packet and retrieving a header checks whether or not the context of the inversely multiplexed packet is synchronized with the context of a previously received packet before retrieving the compressed header. If the context of the inversely multiplexed packet is synchronized with the context of the previously received packet, the unit 122 for inversely multiplexing a packet and retrieving a header retrieves the compressed header using information on a previously retrieved header, which has been stored in the storing unit 123. The packet having a retrieved IP/UDP/RTP header is transmitted to a functioning unit (not shown).

On the other hand, if the context of the inversely multiplexed packet is not synchronized with the context of the previously received packet, the unit 122 for inversely multiplexing a packet and retrieving a header generates the context state packet (CONTEXT_STATE) and transmits the context state packet (CONTEXT_STATE) via the packet transmitter 124 rather than retrieving the compressed header. Here, the context state packet (CONTEXT_STATE) is a packet requiring full header information including context information, which is shown in FIG. 6. In FIG. 6, a CONTEXT_COUNT field is a CONTEXT number, and a V field is a validation bit. When the V field is 1, its corresponding context is not valid. Accordingly, if the V field of a context state packet output from the packet receiver 104 is set to 1, the processor 103 controls the unit 101 for compressing a header and multiplexing a packet so that a full header of a packet corresponding to a predetermined sequence number can be transmitted.

The storing unit 123 stores a header normally retrieved by the unit 122 for inversely multiplexing a packet and retrieving a header and its context, field, and variation.

When a packet to be transmitted from the end terminal 120 to the server 100 is internally generated, the packet transmitter 124 transmits the packet to the IP network 110. The end terminal 120 may provide a packet having a header compressed in the same manner as performed in the server 100 to the packet transmitter 124.

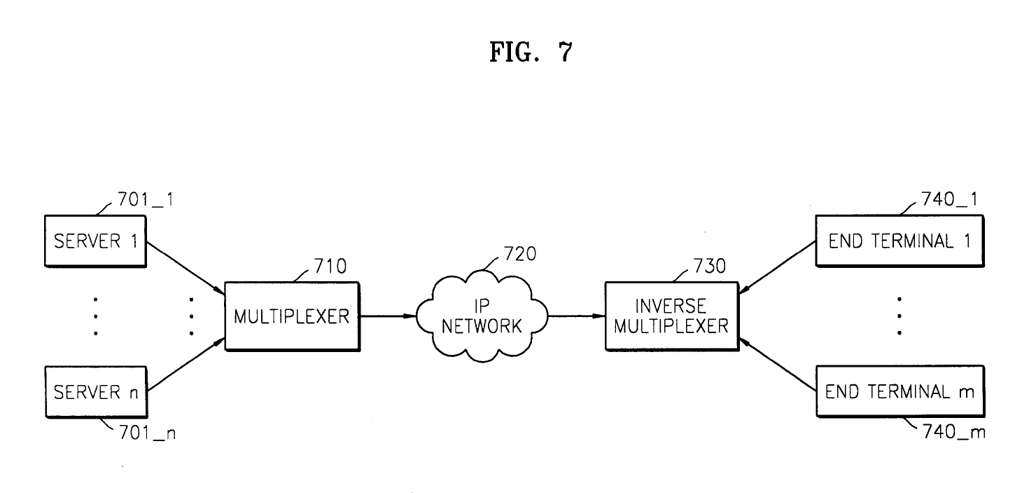

FIG. 7 is a diagram illustrating an example of an IP-based network, to which an apparatus for compressing a header and multiplexing a packet according to another exemplary embodiment of the present invention is applied. The IP-based network shown in FIG. 7 supports multiplexing performed between different end terminals.

Like the server 100 shown in FIG. 1, a server 1 through a server n (701_1 through 701_n) each generate a packet having a compressed header through multiplexing.

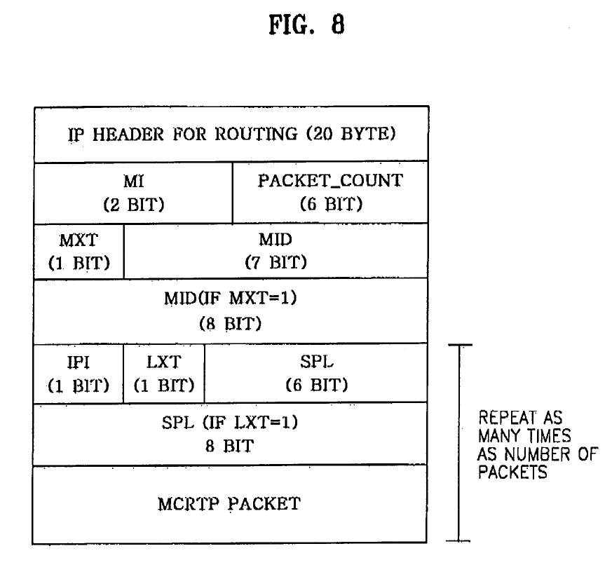

A multiplexer 710 performs packet multiplexing, which supports an MCRTP, on each of the packets generated by the server 1 through the server n (701_1 through 701_n). The format of a packet multiplexed by the multiplexer 710 is shown in FIG. 8. Fields of the multiplexed packet shown in FIG. 8 are shown in Table 3 below.

TABLE 3

| Fields (number of bits) | Functions |
|---|---|
| MI (2) | Multiplexing indication |
| MXT (1) | MID extension |
| MID (7 or 15) | Multiplexing identification |
| IPI (1) | IP indication |

The MID field shown in FIG. 8 is represented by 1 byte if a least significant bit is 0. Accordingly, the MID field is represented by 2 bytes if the least significant bit is 1. A method of synchronizing on the MID field between servers 701_1 through 701_n and end terminals 740_1 through 740_m is the same as a method of synchronizing on the CID field. The IPI field indicates whether or not a multiplexed packet lacks an IP header.

An IP network 720 has the same structure as the IP network 110 shown in FIG. 1. An inverse multiplexer 730 retrieves a multiplexed packet in an inverse method of the multiplexing method performed in the multiplexer 710, and transmits the retrieved packet to an end terminal 1 through an end terminal m (740_1 through 740_m).

The end terminal 1 through the end terminal m (740_1 through 740_m) each have the same structure as the end terminal 120 shown in FIG. 1.

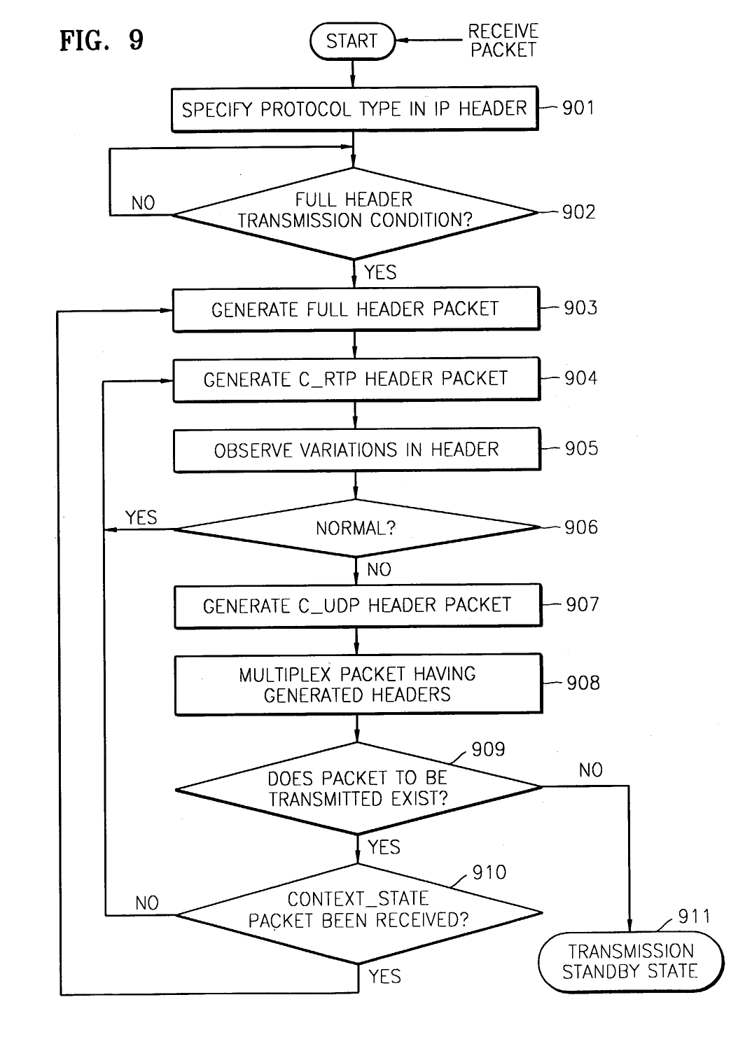

FIG. 9 is a flowchart of a method of compressing a header and multiplexing a packet according to an exemplary embodiment of the present invention. Referring to FIG. 9, a protocol type is specified (or designated) in an IP header of a packet including a non-compressed IP/UDP/RTP header, in step 901, when the packet is received. Next, it is checked whether or not a condition of a current operation for transmitting a packet is a full header transmission condition in step 902. The full header transmission condition has already been described with reference to FIG. 1. If the condition of the current packet transmission operation turns out to be the full header transmission condition in step 902, a packet having a non-compressed full header format, in which a UDP length field is defined, is generated, as shown in FIG. 2.

In step 904, a packet including a compressed C_RTP header having the format shown in FIG. 3 is generated. In step 905, variations in a header are observed in order to check if a field, which varies regularly or is maintained at a predetermined value, among RTP header fields varies irregularly, as mentioned above in the explanation of the unit 101 for compressing a header and multiplexing a packet of FIG. 1.

As a result of the observation, if it turns out in step 906 that the field that varies regularly or is maintained at a predetermined value does not vary irregularly, the method goes back to step 904. However, if the corresponding field of the RTP header is considered to vary irregularly in step 906, a packet having a C_UDP header is generated in step 907. The format of the C_UDP header is shown in FIG. 4.

In step 908, the packet having the aforementioned headers is multiplexed following the multiplexing method, which has been described above.

If it is determined that there exists a packet to be transmitted in step 909, the verification of whether or not a context state packet has been received takes place in step 910. If the context state packet has not yet been received, the method goes back to step 904. However, if the context state packet has been received, which means that the corresponding end terminal demands a full header, the method goes back to step 903.

If it is considered that there is no packet to be transmitted in step 909, the method moves on to step 911, and a current state is determined as a packet transmission standby state.

Accordingly, it is possible to multiplex and transmit a packet having a non-compressed IP header, a compressed UDP header, and a compressed RTP header through the processes shown in FIG. 9. In addition, a protocol type is specified in the IP header, as mentioned above with reference to FIG. 1. For example, if a predetermined type of protocol, such as an MCRTP, is specified in the IP header, it is possible to represent the method of compressing a header and multiplexing and transmitting a packet according to the present invention. Accordingly, it is possible to transmit a packet with a header compressed independently to a link layer.

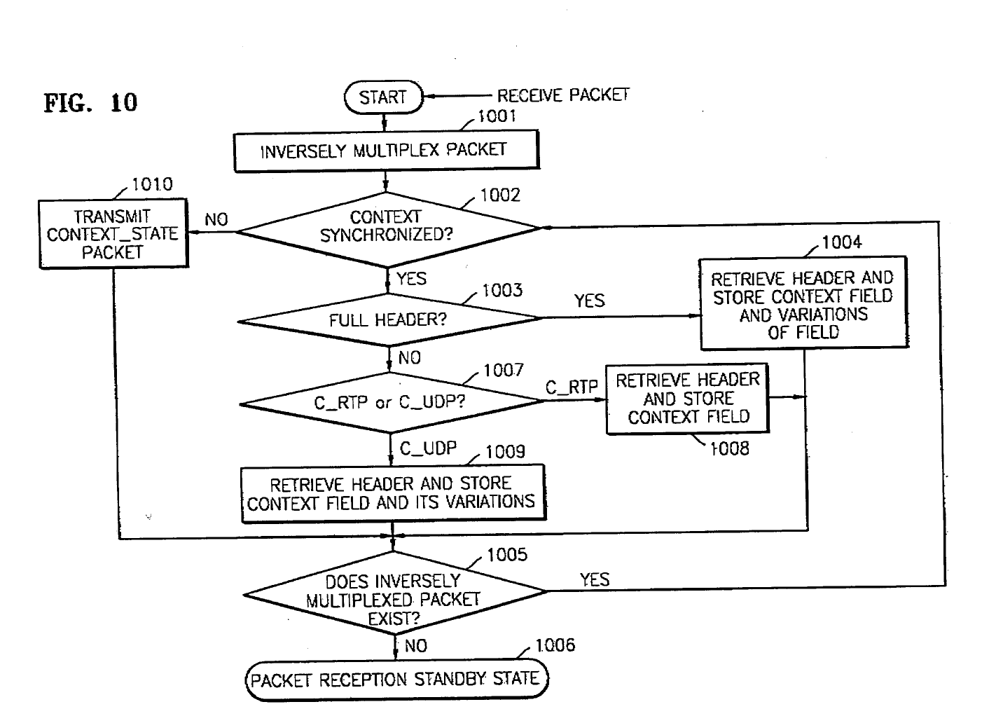

FIG. 10 is a flowchart of processes performed in the end terminal 120 on a packet received following the method of compressing a header and multiplexing a packet shown in FIG. 9.

When a multiplexed packet having a compressed header, which has been generated through the processes shown in FIG. 9, is received, the received packet is inversely multiplexed in step 1001. Next, it is determined whether or not the context of the inversely multiplexed packet is synchronized with the context of a previously received packet in step 1002 using a SEQUENCE_NUMBER or a check sum.

If the context of the inversely multiplexed packet is synchronized with the context of the previously received packet, i.e., if there is no error existing in the inversely multiplexed packet, the type of the inversely multiplexed packet is checked in step 1003. If the inversely multiplexed packet has a full header format, a header of the inversely multiplexed packet is retrieved, and its context field, and variations in the field are stored, in step 1004. Next, it is checked whether or not there still exists an inversely multiplexed packet in step 1005. If an inversely multiplexed packet still exists, the method goes back to step 1002. However, if there is no inversely multiplexed packet left, the method moves on to step 1006, and a current state is determined as a packet reception standby state.

If it is considered in step 1003 that the inversely multiplexed packet does not have a full header format, it is checked whether the inversely multiplexed packet has a C_UDP or a C_RTP in step 1007. If the inversely multiplexed packet is a C_RTP, the header of the inversely multiplexed packet is retrieved in step 1008, a field of the corresponding context is updated, and the method goes back to step 1005. However, if the inversely multiplexed packet is a C_UDP, the header of the inversely multiplexed packet is retrieved in step 1009, and a field of the corresponding context and a variation in the field are updated, and the method goes back to step 1005.

If it is considered in step 1002 that the context of the inversely multiplexed packet is not synchronized with the context of the previously received packet, a CONTEXT_STATE packet is transmitted to the server 100 in step 1010, and the method goes back to step 1005.

As described above, since header compression and packet multiplexing are performed irrespective of a link layer in the present invention, it is possible to apply the present invention to any application where IP packets are used. In addition, it is possible to omit an IP header repeated for routing by multiplexing a packet having a compressed header using an RTP packet multiplexing method, and thus, it is possible to reduce a loss in network bandwidth caused by a non-compressed IP header. Moreover, it is possible to use network bandwidth more effectively especially when there are many packets to be multiplexed.

The present invention supports header compression in a network not adopting PPP tunnelling, header compression performed between packet multiplexing units, and header compression between end terminals. Accordingly, it is possible to increase the compression rate of data to be transmitted considerably faster than in the prior art, which leads to the effective use of network bandwidth.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for compressing a header and multiplexing a packet in an Internet Protocol (IP)-based network environment, the apparatus comprising:
a protocol type designator which specifies a protocol type in an IP header included in a first packet having a non-compressed header when the first packet is received;
a header compressor which generates a second packet having the IP header, the protocol type which has been designated corresponds to one of a full header format, a compressed RTP (C_RTP) header format, and a compressed UDP (C_UDP) header format; and
a packet multiplexer which multiplexes the second packet generated by the header compressor.

2. The apparatus of claim 1, wherein the full header format of the second packet is the same as the format of the non-compressed header of the first packet.

3. The apparatus of claim 2, wherein the second packet includes at least one of a packet type, a context identification (CID), a sequence number (SEQUENCE_NUMBER), a generation number (GENERATION_NUMBER), and a header check sum (C_BIT), using a length field of a UDP header included in the non-compressed header of the first packet.

4. The apparatus of claim 2, wherein the header compressor does not include an IP address in the CID.

5. The apparatus of claim 1, wherein the header compressor generates the second packet having the compressed RTP header format by compressing a field among RTP header fields, which varies regularly or is maintained at a predetermined value.

6. The apparatus of claim 1, wherein the header compressor generates the second packet having the compressed UDP header format if the compressed RTP header format varies irregularly.

7. The apparatus of claim 1, wherein the packet multiplexer performs RTP packet multiplexing so that a loss in network bandwidth, which is caused by a non-compressed IP header of the second packet output from the header compressor, is reduced.

8. The apparatus of claim 1, wherein the header compressor generates a third packet having the full header format when a context state packet is received from a terminal, where the second packet has been transmitted via the network.

9. An apparatus for multiplexing a packet in an IP-based network environment, the apparatus comprising:
a multiplexer which, when packets each having a compressed header are generated by a plurality of servers, multiplexes the packets and generates a multiplexed packet having a multiplexing indication (MI) field, a multiplexing identification extension (MXT) field, a multiplexing identification (MID) field, and an IP indication field.

10. A method of compressing a header and multiplexing a packet in an IP-based network environment, the method comprising:
specifying a protocol type in an IP header of a first packet having a non-compressed header when the first packet is received;
generating a second packet having a compressed header corresponding to one of a full header format, a compressed RTP (C_RTP) header format, or a compressed UDP (C_UDP) header format, depending on an operational condition during transmission of the first packet; and
multiplexing the generated second packet and transmitting the multiplexed packet to a network.

11. The method of claim 10, wherein the full header format of the second packet is the same as the format of the non-compressed header of the first packet, the second packet having the full header format is generated using a length field of a UDP header included in the non-compressed header of the first packet.

12. The method of claim 11, wherein the second packet includes at least one of a packet type, a context identification (CID), a sequence number (SEQUENCE_NUMBER), a generation number (GENERATION_NUMBER), and a header check sum (C_BIT).

13. The method of claim 12, wherein in the generation of the second packet, an IP address is not included in the CID.

14. The method of claim 10, wherein the second packet is multiplexed through RTP packet multiplexing so that a loss in network bandwidth, which is caused by a non-compressed IP header of the second packet input in the compression of the header, is reduced.

15. The method of claim 10, wherein in the compression of the header, a third packet having the full header format is generated when a context state packet is received from a terminal where the second packet has been transmitted via the network.
